(19) United States
(12) Patent Application Publication
(10) Pub. No.: US 2009/0138298 A1
(43) Pub. Date: May 28, 2009

(54) SYSTEM AND METHOD FOR GENERATING A FACT SHEET USED FOR MANAGING THE BUSINESS CONFIGURATION VIEWS

(76) Inventors: JOHAN CHRISTIAAN PETERS, Sankt Leon-Rot (DE); SEBASTIAN SCHOLZ, Saabruecken (DE); MICHAEL RICHTER, Hamburg (DE)

Correspondence Address: SAP AG, 3410 HILLVIEW AVENUE, PALO ALTO, CA, 94304, US

(21) Appl. No.: 11/946,046

(22) Filed: Nov. 28, 2007

(51) Int. Cl. G06Q 10/00

(52) U.S. Cl. 705/7

(57) ABSTRACT

Disclosed is a system and a method for generating a fact sheet for managing the business configuration views. A business configuration view is the user interface for maintaining business configuration sets, the business configuration view which consists of one or more screens. The business configuration set is a set of reusable configuration parameters. The business configuration view can be modeled and provided as a business option. A fact sheet is generated based on this business option and the modeled business configuration view. The fact sheet may have one or more sections that are linked with one or more business configuration views.

### FIELD OF THE INVENTION

Embodiments of the invention generally relate to the field of software business configuration sets, more particularly to an improved solution for managing the business configuration sets.

### BACKGROUND OF THE INVENTION

During software application customization, the software implementation must be customized as per the client's business requirements. This customization of software requires several changes based on the customers business needs. Often this customization is very costly as it is time consuming, many repetitive tasks have to performed, and this effort is customer specific and not reusable. The cost of owning and maintaining such a software application is high.

For example, some enterprise resource planning (ERP) software uses the business configuration sets to support and execute the software sales and implementation process. These business configuration sets store a multitude of country and industry-specific configuration settings.

During the sales and implementation phase for software, the sales engineer and the customer can select functionality to be activated from the business configuration sets. When the customer saves his scoping decisions, the relevant business configuration sets may be loaded and in the background the transformation may be executed. Before deployment, the customer may do fine tuning on the activated settings by using the business configuration views, which are designed user interfaces to allow easy configuration.

In the known technology, the design of the user interface and the customer-specific data is coupled to the business configuration. What is needed is a system and a method that allows for the decoupling of this business configuration including the design of the new business configuration set and the customer-specific data. The decoupling can greatly assist the maintenance and the deployment of such a system because the necessary business configuration settings and the customer-specific data will be directly maintained.

### SUMMARY OF THE INVENTION

Disclosed is a system and a method for generating a fact sheet for managing the business configuration views. A business configuration view is the user interface for maintaining business configuration sets, the business configuration view which consists of one or more screens. The business configuration set is a set of reusable configuration parameters. The business configuration view can be modeled and provided as a business option. A fact sheet is generated based on this business option and the modeled business configuration view. The fact sheet may have one or more sections that are linked with one or more business configuration views.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a flow diagram illustrating the generation of a fact sheet, according to an embodiment of the invention.

FIG. 2 is a flow diagram illustrating in detail the generation of the fact sheet, according to an embodiment of the invention.

FIG. 3 is a system block diagram of an implementation for generating the fact sheet, according to an embodiment of the invention.

FIG. 4 is a graphical user interface illustrating a fact sheet generated at run time, according to an embodiment of the invention.

FIG. 5 depicts a relationship between a business catalog and a business configuration view, according to an embodiment of the invention.

FIG. 6 depicts the relationship between a business catalog and a business configuration view, according to an embodiment of the invention.

FIG. 7 depicts the relationship between a business catalog and a business configuration view, according to an embodiment of the invention.

FIG. 8 illustrates a fact sheet generated according to an embodiment of the invention.

### DETAILED DESCRIPTION

Disclosed is a system and a method for generating a fact sheet for managing the business configuration views. A business configuration view is the user interface for maintaining business configuration sets, the business configuration view which consists of one or more screens. The business configuration set is a set of reusable configuration parameters. The business configuration view can be modeled and provided as a business option. A fact sheet is generated based on this business option and the modeled business configuration view. The fact sheet may have one or more sections that are linked with one or more business configuration views.

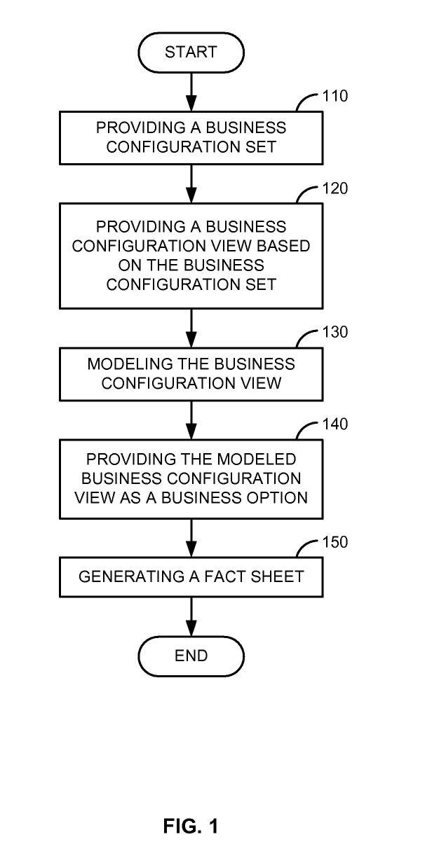

FIG. 1 is a flow diagram illustrating the generation of a fact sheet, according to an embodiment of the invention. At 110, a business configuration set is provided and at 120, a business configuration view is provided based on the business configuration set. In an embodiment one or more business configuration sets may be combined into a business configuration view. At 130, the business configuration view is modeled. The modeling includes fine tuning or providing configuration to the business configuration view. At 140, the modeled business configuration view is provided as a business option. At 150, a fact sheet is generated using the modeled business configuration view and business option.

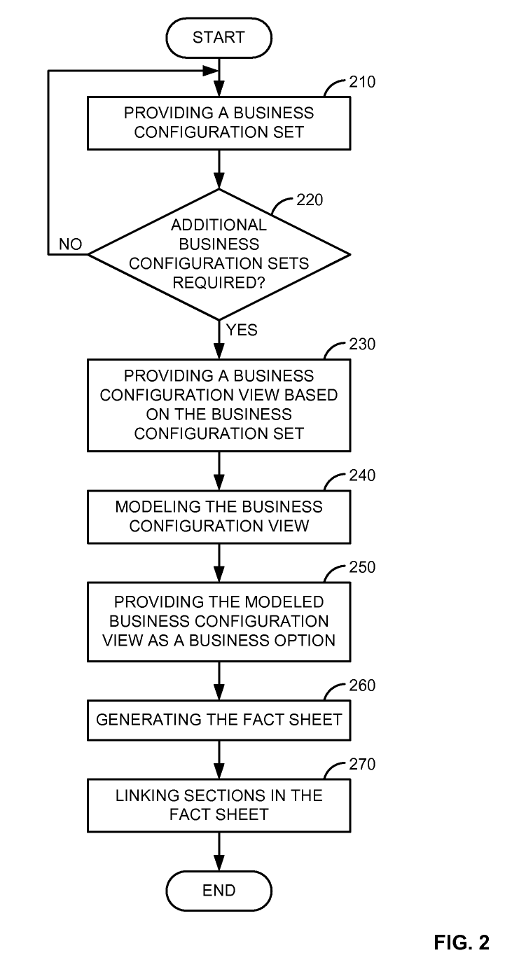

FIG. 2 is a flow diagram illustrating in detail the generation of the fact sheet, according to an embodiment of the invention. At 210, a business configuration set is provided and at 220, check whether any additional business configuration sets are required. If at 220 additional business sets are required flow control returns to 210 otherwise at 230, a business configuration view is provided based on the business configuration set. In an embodiment one or more business configuration sets may be combined into a business configuration view. At 240, the business configuration view is modeled. The modeling includes fine tuning or providing pre-configuration to the business configuration view. At 250, the modeled business configuration view is provided as a business option. At 260, a fact sheet is generated using the modeled business configuration view and business option. At 270, the sections of the fact sheet are linked to the business configuration views.

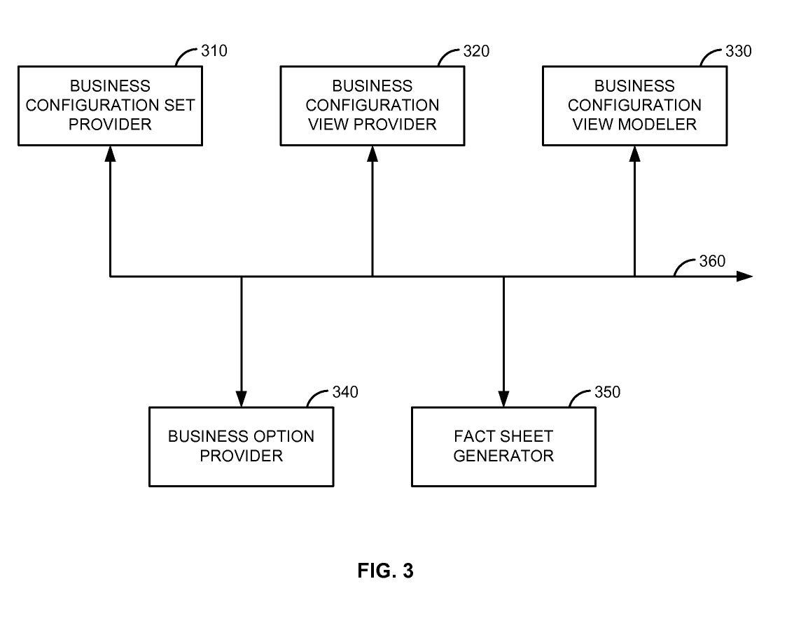

FIG. 3 is a system block diagram illustrating an implementation for generating the fact sheet, according to an embodiment of the invention. The business configuration set provider 310 provides for business configuration sets. A business configuration view provider 320 provides for business configuration view. Multiple business configuration sets can be combined into a single business configuration view. The business view modeler 330 models the business views based on the customer requirements. The business option provider 340 provides the modeled business configuration view as a business option. Multiple business options may be based on the same business configuration view and these business options may have different user interfaces. After the selection of the business option, it is configured to fit the user's business need. A fact sheet generator 350 generates the fact sheet, the fact sheet is a container for one or more business configuration sets. Further the fact sheet acting as a container offers the user an introduction to and an overview of the various settings contained by the underlying business configuration sets. A connector 360 connects the business configuration set provider 310, the business configuration view provider 320, the business view modeler 330, the business option provider 340 and the fact sheet generator 350. In another embodiment, the functionality of the illustrated system components (310, 320, 330, 340, 350) may be implemented as program code modules in a conventional computing device.

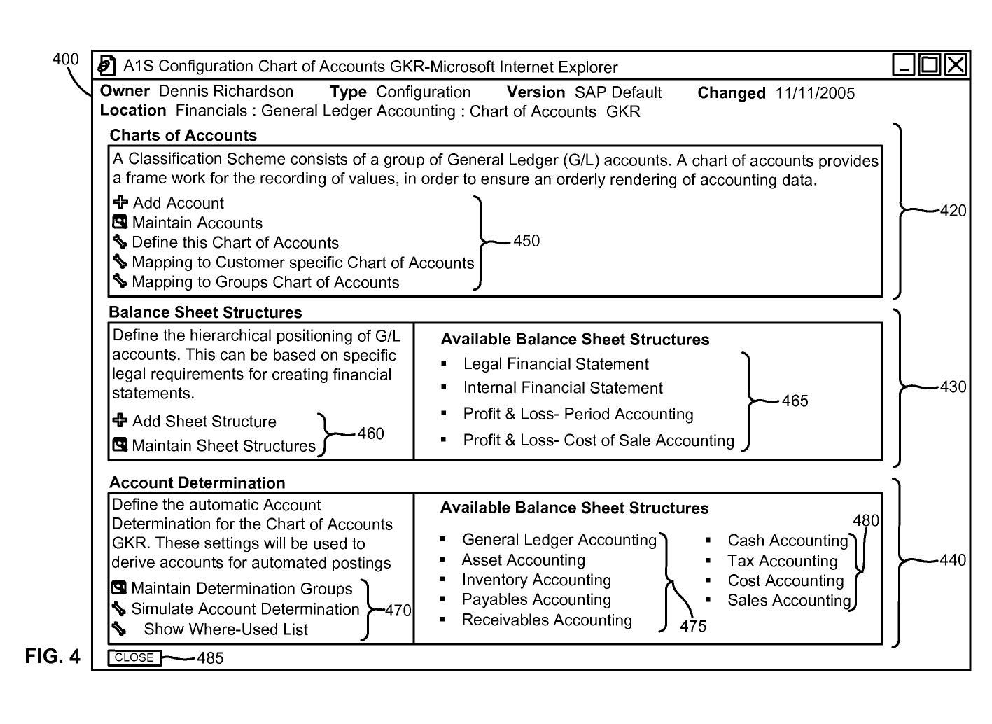

FIG. 4 is a graphical user interface illustrating a fact sheet 400 generated at run time, according to an embodiment of the invention. As depicted the fact sheet 400 contains context-specific business settings and hence acts as a container or a configuration hub also called a dash board, for one or more business configuration sets. This container offers the user an introduction to and an overview of the various settings contained by the underlying business configuration sets. The fact sheet has several sections such as Chart of Accounts 420, Balance Sheet Structure 430 and Account Determination 440 and each section 420, 430 and 440 of the fact sheet 400 links to at least a single business configuration view. Each section 420, 430 and 440 of the fact sheet 400 has links to several underlying user screens. For example, section 420 of the fact sheet 400 is used for maintaining accounts information using the Chart of Accounts links 450. Similarly, section 430 is used for balance sheet management using the Balance Sheet Structure links 460 and Available Balance Sheet Structures links 465. The section 440 is used for account determination using the Account Determination links 470, 475 and 480. The fact sheet 400 can be closed using “Close” button 485.

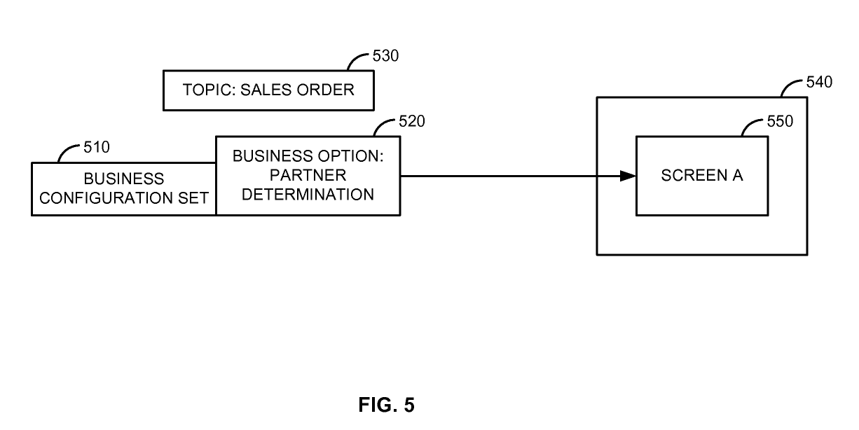

FIG. 5 depicts the relationship between a business catalog and a business configuration view, according to an embodiment of the invention. The business catalog contains business options and business topics. As illustrated, the business configuration set 510 is connected to the business option 520 for Partner Determination for the topic Sales Order 530 of the business catalog. In the given scenario, one business configuration view 540 contains one screen Screen A 550 as illustrated.

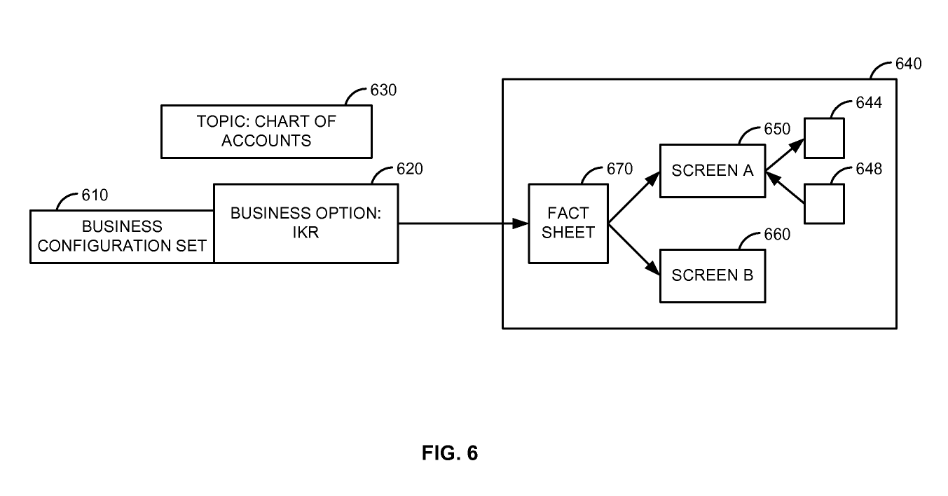

FIG. 6 depicts the relationship between a business catalog and a business configuration view, according to an embodiment of the invention. As illustrated, the business configuration set 610 is connected to the business option 620 for IKR for the topic Chart of Accounts 630. As depicted, one business configuration view contains several screens such as Screen A 650 and Screen B 660, these screens can be combined by a single fact sheet 670. In another embodiment, task related screen 644 and 648 can be accessed in a sequence to provide a context.

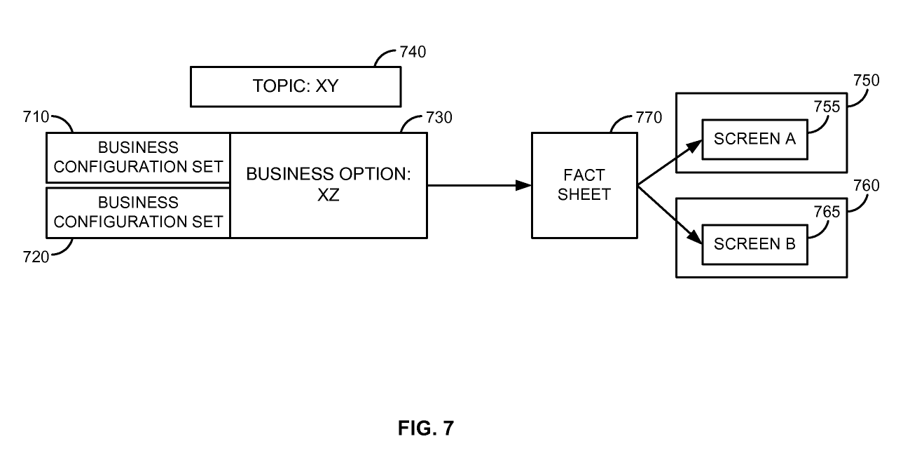

FIG. 7 depicts the relationship between a business catalog and a business configuration view, according to an embodiment of the invention. As illustrated, the business configuration set 710 and 720 are connected to the business option XZ 730 for the topic XY 740. As depicted, two business configuration views 750 and 760 can be combined to generate a single fact sheet 770. Further the business configuration view 750 having at least one screen Screen A 755 and the business configuration view 760 having at least one screen Screen B 765.

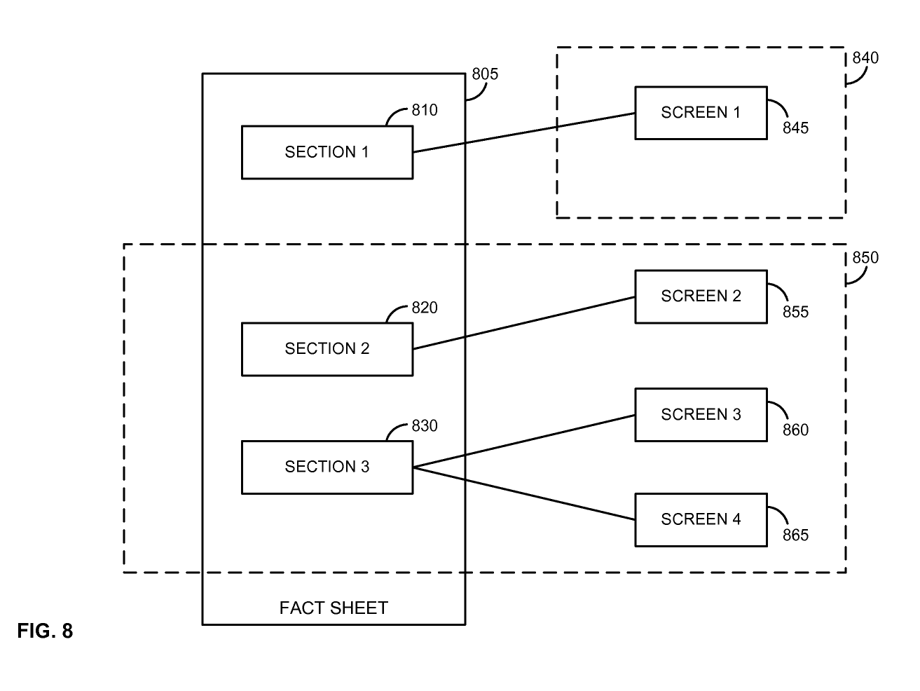

FIG. 8 illustrates a fact sheet generated, according to an embodiment of the invention. As illustrated, the fact sheet generated may have several sections such as Section 1 810, Section 2 820 and Section 3 830. The two business configuration views 840 and 850 are assigned to a business option. At runtime, the fact sheet will have one or more programmed sections and one or more generated sections. The generated section Section 810 is a simplified section having only a short description and one link to the underlying business configuration view 840 having a user interface Screen 1 845. The programmed sections Section 2 820 and Section 3 830 uses business configuration view 850 having user interfaces Screen 2 855, Screen 3 860 and Screen 4 865.

Other embodiments of the invention may be implemented in digital electronic circuitry, or in computer hardware, firmware, software, or in combinations of them.

As described above and with reference to FIG. 3, elements of the invention may also be provided as a machine-readable medium for storing the machine-executable instructions. The machine-readable medium may include, but is not limited to, Flash memory, optical disks, CD-ROMs, DVD ROMs, RAMs, EPROMs, EEPROMs, magnetic or optical cards, propagation media, file server or peer-to-peer download, or other type of machine-readable media suitable for storing electronic instructions.

Throughout the foregoing description, for the purposes of explanation, numerous specific details were set forth in order to provide a thorough understanding of the invention. It will be apparent, however, to one skilled in the art that the invention may be practiced without some of these specific details. The underlying principles of the invention may be employed using a virtually unlimited number of different types of input data and associated actions.

Accordingly, the scope and spirit of the invention should be judged in terms of the claims and equivalents which follow.

What is claimed is:

1. A method comprising:
providing a business configuration set;
providing a business configuration view based on a business configuration set;
modeling the business configuration view;
providing the modeled business configuration view as a business option; and
generating a fact sheet using the modeled business configuration view and the business option.

2. The method of claim 1, wherein the business configuration set comprises of one or more business configuration sets.

3. The method of claim 1, wherein the business configuration set comprises a schema having a configuration table.

4. The method of claim 1, wherein the business configuration view comprises a combination of one or more business configuration sets.

5. The method of claim 1, wherein generating a fact sheet comprises linking the business configuration view to a section of the fact sheet.

6. The method of claim 1, wherein the fact sheet comprises one or more sections.

7. The method of claim 5, wherein the section of the fact sheet comprises a model-able business option and the business configuration view.

8. The method of claim 5, wherein generating a fact sheet comprise auto-generating the section of the fact sheet.

9. The method of claim 1, wherein generating a fact sheet comprises generating content of an underlying screens depending on the business option.

10. The method of claim 1, wherein generating a fact sheet comprises generating a fact sheet at run time.

11. The method of claim 5, further comprising:
generating the fact sheet based on a change to the business configuration view or a change to the business option or a change to the section the fact sheet; and
updating the section of the fact sheet based on a received change.

12. The method of claim 5, wherein the section comprises linking the section to the underlying screen of the business configuration view.

13. A system, comprising:
a business configuration set provider to provide a business configuration set;
a business configuration view provider electronically coupled to the business configuration set provider to provide a business configuration view based on the business configuration set;
a business configuration view modeler electronically coupled to the business configuration set provider and to the business configuration view provider, to model a business configuration view;
a business option provider electronically coupled to the business configuration set provider, to the business configuration view provider and to the business configuration view modeler, to provide a modeled business configuration view as a business option; and
a fact sheet generator electronically coupled to the business configuration set provider, to the business configuration view provider, to the business configuration view modeler and to the business option provider for generating a fact sheet.

14. An article of manufacture, comprising:
a machine readable medium having instructions that when executed by a machine cause the machine to execute a method, comprising:
providing a business configuration set;
providing a business configuration view based on a business configuration set;
modeling the business configuration view;
providing the modeled business configuration view as a business option; and
generating a fact sheet using the modeled business configuration view and the business option.

15. The article of manufacture in claim 14, wherein generating a fact sheet comprises linking the business configuration view to a section of a fact sheet.

16. The article of manufacture in claim 14, wherein the fact sheet comprises one or more sections.

17. The article of manufacture in claim 14, wherein generating a fact sheet comprises auto-generating the section of a fact sheet.

18. The article of manufacture in claim 14, wherein generating a fact sheet comprises generating a fact sheet at runtime.

19. The article of manufacture in claim 15, further comprising:
generating the fact sheet based on a change to the business configuration view or a change to the business option or a change to the section the fact sheet; and
updating a section of the fact sheet based on a received change.

20. The article of manufacture in claim 15, wherein the section comprises linking the section to an underlying screen of the business configuration view.
